(19) United States
(12) Patent Application Publication
(10) Pub. No.: US 2003/0099192 A1
(43) Pub. Date: May 29, 2003

(54) Method and system for a switched virtual circuit with virtual termination

(76) Inventors: Stacy Scott, Allen, TX (US); Gert Oster, Jorfolla (SE); Jan Lindquist, Plano, TX (US); Stefan Petersson, Frisco, TX (US); Anders Kawe, Alvsjo (SE); Johan Appelbom, Alvsjo (SE); Kurt Schoppe, Allen, TX (US)

Correspondence Address: Sidney L. Weatherford, 6300 Legacy Drive MS/EVW2-C-2, Plano, TX, 75024, US

(21) Appl. No.: 09/996,488

(22) Filed: Nov. 28, 2001

(51) Int. Cl. H04J 1/16; H04J 3/14

(52) U.S. Cl. 370/229; 370/410; 370/236

(57) ABSTRACT

According to the present invention, a method and system for communicating via a switched virtual circuit (SVC) is provided wherein transmission traffic is monitored between two ATM switches. When call traffic between the two switches increases above a predetermined level, at least one SVC can be established. At least one, and typically more than one, idle SVC is established and maintained by a media gateway controller utilizing a virtual termination in each switch that is connected to each end of the SVC. This allows end users to be connected to and disconnected from the SVC, without the need to establish or break down the SVC. The SVC remains connected between the switches as long as a predetermined threshold value of packet data transmissions is exceeded. The SVC is torn down when the level of transmissions goes below a predetermined level.

### BACKGROUND OF THE INVENTION

1. Technical Field

The present invention relates generally to data communication networks and more particularly, relates to Asynchronous Transfer Mode (ATM) networks and communication between ATM switches.

2. Description of the Related Art

ATM is a connection-oriented data transport service. When two end users attempt to communicate utilizing the network, an origination ATM switch and a destination ATM switch are used to connect the end users. The ATM switches provide a User Network Interface (UNI) to interconnect the ATM end users to each ATM switch and to each switch via a communication path or, “virtual circuit” (VC). In other words, a session, or virtual connection is negotiated and established between the two switches.

In order to meet a certain quality of Service (QoS) and bandwidth criteria, the origination and destination switches and all other switches between the two switches, negotiate a certain bandwidth to meet the end user requirements. Resources are reserved by establishing a virtual connection link or “pipe” between the two end users. After the virtual connection is assigned and established for a particular communication, all communication between the originating end user and the destination end user are transported utilizing this assigned VC. Accordingly, all ATM packets are transmitted and transported by identifying the assigned VC as the carrier pipe. After the communication between the end users is terminated, the assigned VC is also terminated (“torn down”) and any other relevant resources are released for use by other end users.

Typically, when end users or terminals are in constant communication with each other, rather than establishing and tearing down such a VC on a call basis, a permanent pipe/VC (PVC) is established to serve two end users or switches. One advantage of a permanent connection is that the end switches do not need to repeatedly establish and tear down virtual connections between the two same locations. On the other hand, one of the disadvantages of establishing such a permanent VC (PVC) is that the allocated resource or bandwidth would be wasted if the anticipated amount of communication did not take place between the two users.

Accordingly, there are different ways for communicating between switches in an ATM network. As explained above, PVCs are paths for information transfer between circuit endpoints that are designed to operate and remain established for long periods of time and are normally provisioned by an operator or network management. Alternatively, temporary connections, such as Switched VCs (SVCs), are connected and released via signaling. Rather than being established for a long term, SVCs are typically designed to operate for days, hours or even seconds.

As a result, SVCs provide flexibility for handling voice and data traffic between switches (hereafter interchangeably referred to as nodes) by establishing and “tearing down” per each communication request. Traditionally end users, such as an originating user or application, requests, maintains, and terminates such a SVC. On the other hand, PVCs generally require contracts for service and permanent addresses between nodes. Building up and tearing down a PVC is therefore a major undertaking in contrast to the building and tearing down a SVC.

After end users signal an end to the need for a virtual circuit, the SVC is torn down and any new SVC is installed based on the need for subsequent new requests. However, this procedure consumes a significant amount of time and resources to keep building up and tearing down SVCs.

There is therefore a need for a more efficient mechanism and/or method of establishing and maintaining virtual connections between two end switches that will enable a prompt call connect and call disconnect to a switched virtual circuit for end users. There is also a need to provide an alternative to the present practice of building up then tearing down temporary SVCs.

### SUMMARY OF THE INVENTION

The methods, systems, and arrangements of the present invention overcome the deficiencies of the prior art. A method and system of communication between nodes in a network utilizes a switched virtual circuit (SVC) without the need for frequently establishing and breaking down the SVC between communication episodes. An idle SVC is utilized wherein the SVC may remain connected between nodes without end users being assigned to the SVC.

The limitations inherent in the prior art described above are overcome by establishing temporary connections, e.g., switched virtual circuits between nodes without associated end user connections. Bandwidth usage is monitored between a first and second node (i.e., ATM switches) in a network. When transmissions between the two switches in the network increase above a predetermined level, at least one SVC may be established therebetween. At least one idle SVC may be established utilizing a virtual termination (a dummy address) at each end of the SVC to act as a “place holder.” This procedure allows end users to be connected to and disconnected from the SVC without the need to establish or tear down the SVC. The SVC(s) may remain connected as long as a predetermined, threshold number of installed circuits are active and bearing traffic between switches.

According to an advantageous embodiment, the present invention establishes means for monitoring the packet traffic associated with a predetermined number of virtual terminations in each of the first node and the second node.

According to an alternate embodiment, the present invention connects a predetermined number of SVCs between the first node and the second node according to the results of the monitoring. An equal number of endpoints are utilized on each node, and the SVCs remain established for a period of time that may be adjustable.

In another alternate embodiment of the present invention, a first virtual termination in the first node is assigned to one end of a SVC connected between a first and second nodes. A second virtual termination in a second node is assigned to the other end of the SVC. A first end user associated with the first node may be connected to a second end user associated with the second node by connecting each end user via the SVC to endpoints in the respective node.

An additional embodiment of the present invention may disconnect the SVC if the transmission rate or bandwidth usage between the nodes drops below a threshold value.

The above-described and other features of the present invention are explained in detail hereinafter with reference to the illustrative examples shown in the accompanying drawings. Those skilled in the art will appreciate that the described embodiments are provided for purposes of illustration and understanding and that numerous equivalent embodiments are contemplated herein.

### BRIEF DESCRIPTION OF THE DRAWINGS

Other features and advantages of the invention will become apparent from the following detailed description taken together with the drawings in which:

FIG. 1A illustrates a high-level block diagram of a connectivity network;

FIG. 1B depicts a high-level block diagram of connections between two media gateways according to an embodiment of the present invention;

FIG. 2 illustrates a high-level diagram of a network switched virtual circuit between two end users, according to a preferred embodiment of the present invention;

FIG. 3 is a high-level block diagram of a SVC between two end users illustrating an embodiment wherein the end users are located in different domains within an ATM network according to the present invention; and

FIG. 4 depicts a high-level flow diagram of a process for communicating in an ATM network utilizing a SVC according to the present invention.

### DETAILED DESCRIPTION OF THE INVENTION

In the following description, for purposes of explanation and not limitation, specific details are set forth, such as particular architectures, interfaces, circuits, logic modules (implemented in, for example, software, hardware, firmware, some combination thereof, etc.), techniques, etc. in order to provide a thorough understanding of the invention. However, it will be apparent to one of ordinary skill in the art that the present invention may be practiced in other embodiments that depart from these specific details. In other instances, detailed descriptions of well-known methods, devices, logic code (e.g., hardware, software, firmware, etc.), etc., are omitted so as not to obscure the description of the present invention with unnecessary detail.

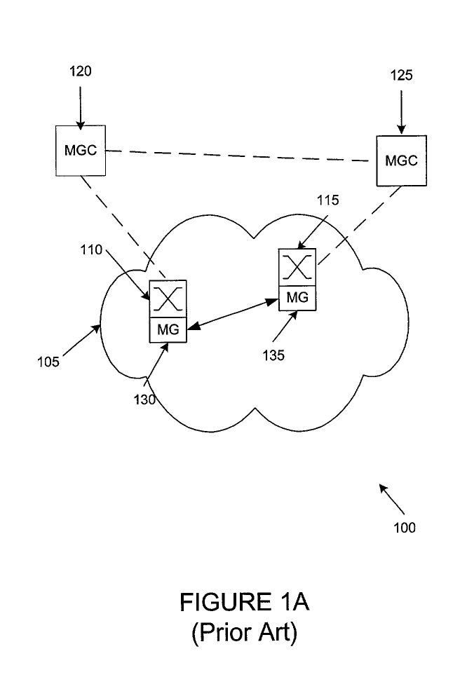

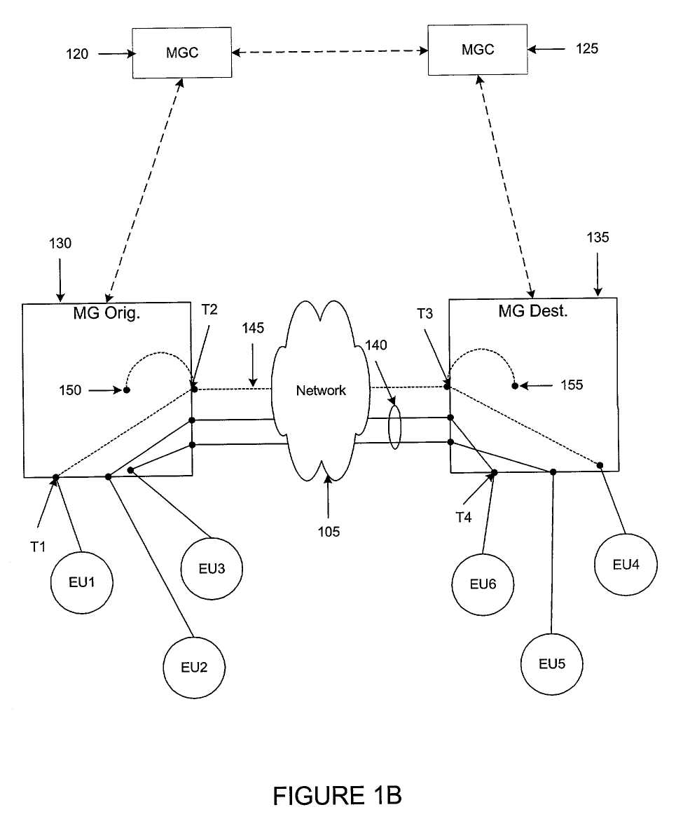

A preferred embodiment of the present invention and its advantages are best understood by referring to FIGS. 1-5 of the drawings, like numerals being used for like and corresponding parts of the various drawings. With reference now to the figures, and in particular with reference to FIG. 1A, a high-level block diagram illustrates a connectivity network according to an embodiment of the present invention. Connectivity network 100 comprises ATM network 105, switches 110 and 115, which include media gateways (MG) 130 and 135, and MG controller (MGC) 120 and MGC 125. MGC 120 and MGC 125, in this instance, are geographically separated. MG 130 and MG 135 are capable of converting media transmissions, i.e., video conferencing, in one network format to another format. MG 130 and MG 135 include a logical set of statically partitioned physical terminations or termination access points.

Also connected to MG 130 and MG 135, but not shown, are end users that communicate via MG 130, switch 110, network 105 and MG 135. A media gateway enables processing of node packet-switched and circuit-switched information in the same gateway allowing operators to implement communication means, including ATM and IP, in a network. Though network 105 is illustrated as an ATM network, the network may be a network involving internodal communications in other types of networks. The type of network over which the communications take place does not limit the method and apparatus of the present invention.

MGC 120 and MGC 125 coordinate and control the connection and communication processes between end users that are connected to MG 130 and 135, utilizing a signaling protocol, such as H.248. The H.248 protocol is a signaling protocol that enables the MGC, among other functions, to control connections in media gateways. MGC commands generally relate to establishing and releasing connections from end points on media gateways.

Communication channels are set up between MG 130 and MG 135 via network 105 and include permanent virtual circuits (PVCs) and “temporary” Switched Virtual Circuits (SVCs). The PVCs (not shown) are assigned fixed connection endpoints on MG 130 and 135. The fixed endpoint is assigned to a user, usually on a service contract, and the PVCs are always “through” (end users connected) connected during the life, and according to the terms, of the contract. SVCs (not shown) are typically temporary circuits that are signaled circuits between end users.

Media gateway controllers manage a “domain” and may control multiple media gateways within that domain. An MGC utilizes signals from end users to set up PVCs and SVCs between network nodes, media gateways and ultimately the end users. If an end user needs to connect to an end user in a different domain, signals are passed between the MGCs utilizing signaling protocols such as ISUP (ISDN user posts) or DSS (Digital Subscriber Signaling), and virtual circuits are set up between the respective MGs. For illustrative purposes, MGC 120 is depicted as being a separate node from the MG within FIG. 1. However, the functionality and control provided by the MGC may also be incorporated or co-located within the MG 130 or the switch 110.

FIG. 1B depicts a high-level diagram of connections between two media gateways, according to an embodiment of the present invention. MGC 120 and MGC 125 are geographically separated and control MG 130 and MG 135 respectively. Active virtual circuits 140 and SVC 145 are shown connected to both media gateways.

SVC 145 is an idle circuit, i.e., no data traffic is present, that is maintained between MG 130 and MG 135 by using call control half-calls between T2 and virtual termination (VT) 150 and T3 and virtual termination (VT) 155. VT 150 and VT 155 are addresses that have no assigned end users and there is no specific hardware connection for a virtual termination. Essentially VT 150 and VT 155 are “dummy” addresses. When a call control utilizes a virtual termination as one of the half-calls, MG 130 and MG 135 and all intervening switches/nodes perceive SVC 145 as a completed circuit.

In this embodiment of the present invention, end user EU1 originates a videoconference call via MG 130 (Node 1) and MG 135 (Node 2) to end user EU4 utilizing SVC 145 (represented by the dotted lines). End users EU2 and EU3 are depicted as connected to EU6 and EU5 respectively via virtual circuits 140 connected between MG 130 and MG 135.

In accordance with the teachings of the present invention, MGC 120 and MGC 125 monitor the data traffic, or bandwidth usage, between MG 130 and MG 135. The monitored bandwidth is then compared against a particular threshold value associated with that particular communication link or path. As an illustration, a particular threshold value may be assigned for monitoring traffic capacity with a particular destination node. Accordingly, a data table (not shown) specifying a different threshold value, for each path or destination node, may be included within MGC 120. A default threshold value may also be specified for any destination node that is not included within the data table.

The monitored bandwidth or traffic capacity is then compared against a particular threshold value associated with that particular communications link. As explained above, MG 130 may perform the step of monitoring and detecting the traffic capacity or bandwidth. The monitored value is then, for example, communicated over to MGC 120. MGC 120, referencing the data table, then determines whether the reported value has exceeded the appropriate threshold value.

In response to a determination that the monitored capacity has exceeded the threshold value, MGC 120, for example, instructs the associated MG 130 to establish SVC 145 towards a particular destination MG, in this instance MG 135. Further, according to the present invention, since no users are yet assigned to SVC 145, virtual terminations or terminal addresses are assigned to effectuate the connection. Thus, when instructions are passed to the media gateways to connect EU1 to EU4, MG 130 instructs T1 to connect to T2 and MG 135 instructs T4 to connect to T3.

Further, the communication link between EU1 and EU4 may be disconnected when MGC 120 signals MG 130 to disconnect endpoint T1 from T2 and MGC 125 signals MG 135 to disconnect endpoint T3 from T4. The virtual termination, e.g., the dummy address, in each gateway is then assigned to endpoints T2 and T3 in order to maintain SVC 145 between the two MGs. Thus, there is no necessity for tearing down SVC 145.

In summary, each end of SVC 145 is established in both media gateways and is available for use by end users of either media gateway. As shown, endpoints T2 and T3 are the endpoints connecting SVC 145 between the media gateways. SVC 145 is maintained by using the described half-calls between T2 and VT 150 and T3 and VT 155. This arrangement provides for a faster end-to-end establishment of a call since end user EU1 does not wait on network signaling to establish a circuit between nodes.

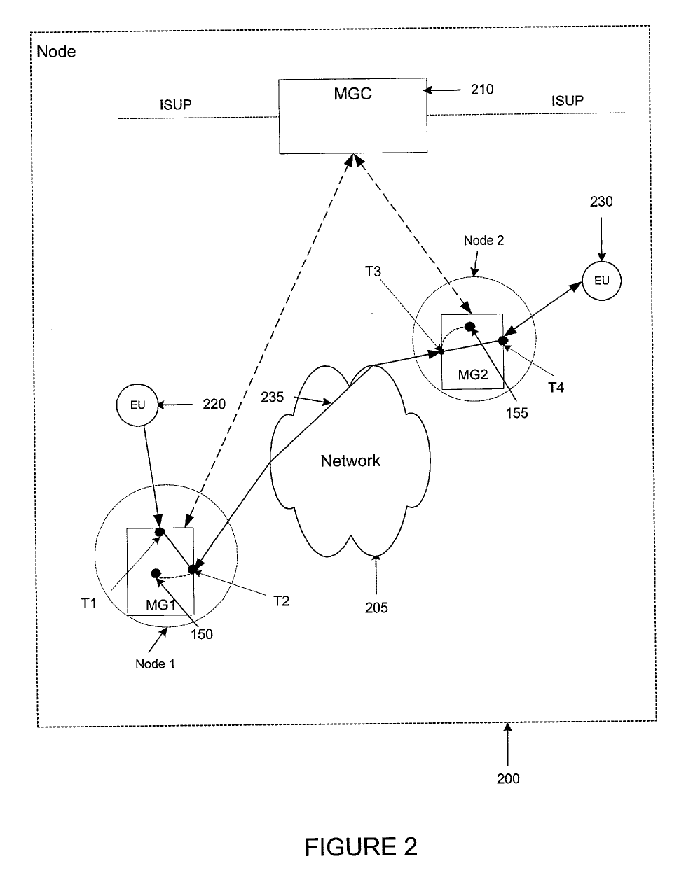

FIG. 2 illustrates a high-level diagram of a network switched virtual circuit between two end users, according to an embodiment of the present invention. MGC 210 controls both MG1 and MG2 utilizing H.248 signaling protocol or a similar protocol. In response to a determination that the monitored traffic between the two MGs exceeds a particular threshold value, MGC 210 signals MG1 and MG2 to set up SVC 235 between T2 and T3 via network 205 according to predetermined parameters. This procedure takes place prior to receiving any request, for connection, from an end user or application. As further explained in FIGS. 1A and 1B, T2 and T3 are virtual terminations assigned by the MGs to establish a SVC between the two nodes.

Thereinafter, a user or application, such as EU 220, requests a call connection with a particular destination user or application EU 230. Such a request is first received by MG1 serving that particular terminal or user. In response to such a request, signaling may be sent from MG1 towards MGC 210. MGC 210 then determines that SVC 235 has already been established between the two nodes (MGs) serving the two EUs and an instruction to connect the two EUs to the already established SVC is provided to the serving MGs. Accordingly, the only effort required to make the connection is for MGC 210 to signal MG1 to connect T1 to T2 and to signal MG2 to connect T3 to T4. Similarly, a request to disconnect the communication link between the EU 220 and EU 230 only requires that MGC 210 signal the media gateways MG1 and MG2 to disconnect endpoint T1 from T2 in MG1 and disconnect T3 from T4 in MG2. The virtual termination, e.g., the dummy address, in each gateway is then assigned to endpoints T2 and T3 in order to maintain SVC 235 between the two MGs. Thus, there is no necessity for tearing down SVC 235.

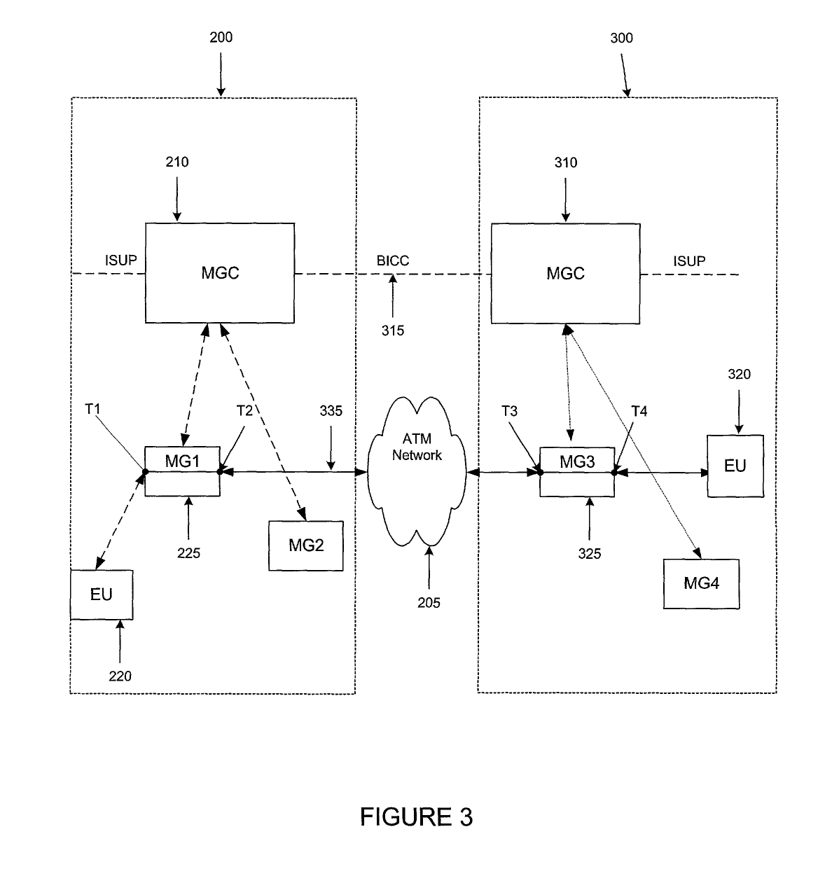

FIG. 3 is a high-level block diagram of a SVC between two end users wherein the end users are located in different MGC domains within an ATM network, according to an embodiment of the present invention. EU 220, utilizing an appropriate signaling protocol signals MGC 210 to provide a connection to EU 320. Signaling 315 is BICC (Bearer Independent Call control) or a similar signaling protocol that is used in inter-domain calls, i.e., between the two media gateway controllers. MGC 210 then signals to MGC 310 to provide a connection to EU 320.

SVC 335 is an idle, switched virtual circuit previously established between the two MGs in accordance with the teachings of the present invention. Data traffic between the MGs is monitored and upon reaching a threshold value, the MGC installs SVC 335. Accordingly, to connect the two end users to effectuate communication therebetween using the already established SVC, MGC 210 instructs EU 220 to connect to endpoint T2 via endpoint T1, a half call interface and virtual termination (neither shown) within MG1. MGC 310 instructs EU 320 to connect to termination T3 via termination T4, half call interface 325 and virtual termination (neither shown). The communication path via SVC 335 is complete and transmissions between EU 220 and EU 320 then take place.

When either end user signals a disconnect, the half call interfaces and virtual termination combinations in MG1 and MG2 225 and 325 are disconnected. However, SVC 335 remains in place connected to endpoints T2 and T3 with the virtual terminations taking the place of EU 320 and EU 220.

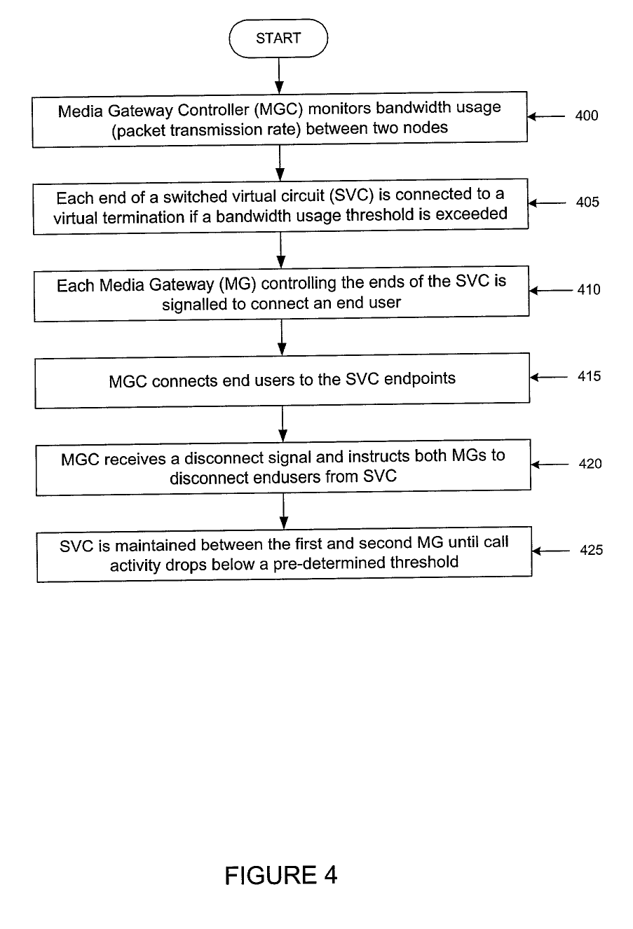

FIG. 4 depicts a high-level flow diagram of a process, for communicating in an ATM network utilizing a SVC according to an embodiment of the present invention. A media gateway controller monitors transmissions on virtual circuits (all circuits including PVCs and SVCs) between two nodes. As further explained above, a particular threshold value may be assigned for each destination node. As a further embodiment of the present invention, a number of different threshold values may be assigned for each destination node to specify a different number of SVCs to be established and maintained between the two nodes. As an illustration, in response to a determination that the monitored traffic has exceeded value X, a first SVC is established and maintained therebetween. In response to a determination that the monitored value has now exceeded value Y, a second SVC is similarly established and maintained between the two nodes. Such threshold values are similarly used for tearing down and disconnecting the SVCs in the event the monitored value falls below a particular value (process step 400).

The MGC instructs the MG to establish a SVC using the virtual termination (dummy address) so that the SVC may be established in a conventional and transparent manner throughout the network. Accordingly, other than the MG assigning a virtual terminal to the SVC, all other functions and steps involved in connecting the SVC are performed in a conventional manner. In response to the MGC receiving a request from a particular end user (via the serving MG) to establish a communication link with a destination user associated with a particular node, the MGC then determines whether there exists a pre-established SVC in accordance with step 400 (process step 405).

In response to an affirmative determination, the originating end user terminal is then connected, or assigned, to the pre-established SVC. The instruction for requesting the destination MGC to connect the destination node to the other end of the SVC may be communicated from the originating MGC, for example, to the destination MGC via a separate communication link (BICC link shown in FIG. 3) (process step 410).

More specifically, the MGC(s) instructs the MG serving the first end user and the MG serving the second end user to disconnect each virtual terminal from the ends of the SVC and connect the end users in place of the disconnected virtual terminals. Since the virtual terminals are software constructs there is no physical connection and no physical switch necessary. (process step 415).

Upon receiving a “disconnect” signal from either end user, the MGC signals each media gateway to disconnect the ends of the SVC from the end users. The ends of the SVC are then reconnected to a virtual terminal constructed in the node fabric by each media gateway. As a result, rather than disconnecting the actual SVC connection between the two serving nodes, terminal connection is merely released and virtual terminations are again assigned to the SVC to maintain the SVC connection between the two MGs. Such SVC can be subsequently utilized by other end users connected to the same MGs for communicating data therebetween (process step 420).

In accordance with the teachings of the present invention, the traffic or data level communicated between the two MGs are continuously monitored even with the establishment of the virtually terminated SVCs. In response to a determination that the monitored capacity has fallen below a particular threshold value, a determination is then made by the MGC, for example, that the semi-permanent SVC is no longer justified or needed between the two nodes. The established SVC is then released and disconnected when there is no further transmission on that path. (process step 425).

Alternative embodiments, as alluded to above, may also include a computer network. Nodes (workstations and servers) on a network can utilize appropriate software applications to establish virtual terminations in a node. The setup and tear down process of the virtual circuits between workstations would parallel the telecommunications embodiment described above. The virtual terminations are available for connecting a workstation, for example, to another workstation in an Intranet, or between Intranets, via pre-established virtual circuits and outside the normal connection between the workstations. Nodes utilizing the virtual termination application can be programmed to provide temporary connections between specific nodes that would carry data traffic when the original link approached a certain level of data traffic or bandwidth usage. Because of the “installed” virtual circuit connection between nodes, connections between the end users would be almost immediate with no need for signaling to establish the circuit.

While the invention has been particularly shown and described with reference to a preferred embodiment, it will be understood by those skilled in the art that various changes in form and detail may be made therein without departing from the spirit and scope of the invention.

What is claimed is:

1. A method for transmitting packet data, comprising the steps of:
monitoring packet data transmission traffic between a first switch and a second switch;
establishing a switched virtual circuit (SVC) wherein a first end of said SVC in said first switch is assigned a virtual termination address, wherein said address is one of a plurality of software generated dummy addresses created in said first switch fabric;
receiving a request from an end user to transmit from said first switch to said second switch; and
assigning said end user to said first end of said SVC.

2. The method as set forth in claim 1 further comprises utilizing a predetermined threshold value of said transmission traffic to determine the number of virtually terminated SVCs to be installed.

3. The method as set forth in claim 1 further comprising the steps of:
receiving a request to disconnect said virtually terminated SVC;
responsive to said request, disconnecting said first end of said virtually terminated SVC from said end user; and
assigning said first end to one of said plurality of dummy addresses, wherein said virtually terminated SVC remains connected.

4. The method as set forth in claim 3, further comprising the step of:
responsive to said transmission traffic dropping below a predetermined level, disconnecting said virtually terminated SVC.

5. The method as set forth in claim 1, wherein the step of establishing further comprises utilizing a media gateway controller to establish said virtually terminated SVC between said first and second switch.

6. The method as set forth in claim 1, wherein said media gateway controller maintains a predetermined number of virtually terminated SVCs until said transmission traffic exceeds said threshold value.

7. The method as set forth in claim 1, wherein said plurality of dummy addresses is created by a media gateway.

8. The method as set forth in claim 1, wherein said network is a telecommunications network.

9. The method as set forth in claim 1, wherein said network is a computer network.

10. In a network, a system for communicating packet data between a first switch and a second switch in a network, comprising:
means for monitoring packet data transmissions between said first and second switches;
a media gateway in each of said first and second switches for generating a plurality of dummy addresses in the switch fabric of each of said first and second switch;
a media gateway controller for installing a switched virtual circuit between said first and second switch; and
means for assigning one of said plurality of dummy addresses to each of a first end and second end of said switched virtual circuit.

11. The system as set forth in claim 10, wherein said media gateway in each of said first and second switches is capable of establishing a predetermined number of said virtual terminations in the switch fabric of each of said first switch and said second switch.

12. The system as set forth in claim 11, wherein said monitoring means further comprises means for comparing a threshold value of said packet data transmission to determine a number of virtually terminated SVCs to be installed.

13. The system as set forth in claim 10, wherein said controller further comprises:
means for receiving a request to disconnect said virtually terminated SVC;
responsive to said request means for disconnecting said first end of said virtually terminated SVC from said end user; and
means for assigning said first end to one of said plurality of dummy addresses, wherein said virtually terminated SVC remains connected.

14. The system as set forth in claim 10, wherein said controller further comprises means for establishing and maintaining said virtually terminated SVC between said first and second switches.

15. The system as set forth in claim 10, comprises means for disconnecting said virtually terminated SVC when said packet data transmission drops below a predetermined level.

16. The system as set forth in claim 10, wherein said controller is capable of maintaining a predetermined number of virtually terminated SVCs until said packet data transmission exceeds said threshold value.

17. The system as set forth in claim 10, wherein said network is a telecommunications network.

18. The system as set forth in claim 10, wherein said network is a computer network.

19. A method for receiving packet data comprising the steps of:
monitoring transmission traffic between a first switch and a second switch;
establishing a switched virtual circuit (SVC) wherein a second end of said SVC in said second switch is assigned a virtual termination address, wherein said address is one of a plurality of software generated dummy addresses created in said second switch fabric;
receiving a signal to receive packet data from said first switch; and
assigning an end user to said second end of said SVC.

20. The method as set forth in claim 19 further comprising utilizing a predetermined threshold value of said transmission traffic to determine the number of virtually terminated SVCs to be installed.

21. The method as set forth in claim 19 further comprising the steps of:
receiving a request to disconnect said virtually terminated SVC; and
responsive to said request, disconnecting said second end of said virtually terminated SVC from said end user and assigning said second end to said one of a plurality of dummy addresses, wherein said virtually terminated SVC remains connected.

22. The method as set forth in claim 19, wherein the step of establishing further comprises:
utilizing a media gateway controller to establish and maintain said virtually terminated SVC.

23. The method as set forth in claim 19, further comprising the step of:
responsive to said packet data transmission dropping below a predetermined level, disconnecting said virtually terminated SVC.

24. The method as set forth in claim 19, wherein said media gateway controller maintains a predetermined number of virtually terminated SVCs as long as said transmission traffic exceeds said threshold value.

25. The method as set forth in claim 19, wherein said media gateway controller maintains a predetermined number of virtually terminated SVCs as long as said transmission traffic exceeds said threshold value.

26. A method for communicating packet data between two switches in a network, comprising:
monitoring packet data transmission traffic between a first switch and a second switch;
utilizing a predetermined threshold value to determine whether to add additional virtual circuits between said first and second switches;
establishing at least one switched virtual circuit (SVC), wherein a first end of said SVC in said first switch and a second end of said SVC in said second switch are each assigned a virtual termination address, wherein each said address are software generated dummy addresses each created in said first and second switch fabric;
receiving a request from a first end user to transmit from said first switch to said second switch; and
assigning said first end user to said first end of said SVC and a second end user to the second end of said SVC;
receiving a disconnect signal from one of said end users; disconnecting each of said first and second end users from said SVC;
connecting said first and second end of said SVC to said virtual termination addresses; and
tearing down said virtually terminated SVC if said packet data transmission drops below a predetermined level.
